(19) United States
(12) Patent Application Publication
(10) Pub. No.: US 2003/0008624 A1
(43) Pub. Date: Jan. 9, 2003

(54) Battery back cover structure of mobile telephone having the function of a hand-free receiver

(76) Inventor: Den-Tsai Su, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/898,587

(22) Filed: Jul. 3, 2001

(51) Int. Cl. H04B 1/38

(52) U.S. Cl. 455/90; 455/575

(57) ABSTRACT

The present invention relates to a battery back cover structure of a mobile telephone having a function of a hand-free receiver, wherein the battery box of the mobile telephone is changed to have the function of a hand-free receiver. The battery box is designed to consist of a battery back cover containing a control circuit board, a horn and a microphone, and a cartridge that may be inserted into the battery back cover. The cartridge is provided with a signal connector that may be inserted into the insertion hole of the mobile telephone body. The cartridge may be pulled outward and rotated to be inserted into the mobile telephone body, such that the signal from the mobile telephone body can be transferred to the cartridge, and then through the cartridge to the control circuit board of the battery back cover, thereby providing the function of a hand-free receiver.

### BACKGROUND OF THE INVENTION

1. Field of the Invention

The present invention relates to a battery back cover structure of a mobile telephone having the function of a hand-free receiver, wherein the inner structure of the battery box of the mobile telephone may be changed to have a cartridge that may be inserted into the battery back cover, thereby easily connecting to the mobile telephone body, so that the mobile telephone body may have the function of a hand-free receiver.

2. Description of the Related Art

An ordinary mobile telephone (or cellular phone) includes various configurations, and the volume of the mobile telephone has become much smaller so as to satisfy the various requirements of the consumers. However, the conventional mobile telephone does not have the function of a hand-free receiver, thereby greatly limiting the versatility of the conventional mobile telephone.

### SUMMARY OF THE INVENTION

The present invention has arisen to mitigate and/or obviate the disadvantage of the conventional mobile telephone.

The primary objective of the present invention is to provide a battery back cover structure of a mobile telephone having a function of a hand-free receiver, wherein the mobile telephone may have the function of a hand-free receiver only having to replace the battery back cover, thereby preventing replacing the whole mobile telephone.

Another objective of the present invention is to provide a battery back cover structure of a mobile telephone having a function of a hand-free receiver, wherein the battery box of the mobile telephone is changed to have the function of a hand-free receiver. The battery box is designed to consist of a battery back cover containing a control circuit board, a microphone and a horn, and a cartridge that may be inserted into the battery back cover. The cartridge is provided with a signal connector that may be inserted into the insertion hole of the mobile telephone body. The cartridge may be pulled outward and rotated to be inserted into the mobile telephone body, such that the signal from the mobile telephone body can be transferred to the cartridge, and then through the cartridge to the control circuit board of the battery back cover, thereby providing the function of a hand-free receiver.

In accordance with the present invention, there is provided a battery back cover structure of a mobile telephone having a function of a hand-free receiver, comprising:

a battery back cover, having an inner wall provided with a horn and a microphone;

a control circuit board of a hand-free receiver, the control circuit board provided on an inner face of the battery back cover; and

a cartridge, inserted into a proper position of the battery back cover, and provided with a signal connector inserted into an insertion hole of a mobile telephone body, and connected to the control circuit board of the hand-free receiver, for transferring a signal from the mobile telephone body to the cartridge, and to the control circuit board of the hand-free receiver.

The control circuit board of the hand-free receiver has a surface provided with electrode elastic plates which directly contact power supply connecting points of a battery of a mobile telephone.

In accordance one embodiment of the present invention, the cartridge is provided with an insertion column which may be inserted into a column hole of the battery back cover, an outer thread is formed on a top of the insertion column, a spring is fitted on the insertion column, and a nut is screwed on the outer thread of the insertion column and is secured in the column hole, thereby preventing the insertion column from detaching from the column hole. The cartridge is pulled downward and rotated, so that the signal connector of the cartridge can be inserted into the insertion hole of the mobile telephone body.

In accordance another embodiment of the present invention, the cartridge is provided with an insertion column which may be inserted into a column hole of the battery back cover, and a catch is mounted on one end of the insertion column to prevent the insertion column from detaching from the column hole.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a battery back cover structure of a mobile telephone having the function of a hand-free receiver in accordance with a first embodiment of the present invention;

FIG. 2 is a front plan view of the battery back cover structure of a mobile telephone having the function of a hand-free receiver as shown in FIG. 1;

FIG. 3 is a perspective view showing the battery back cover structure as shown in FIG. 1 being assembled with a mobile telephone body;

FIG. 4 is a side plan view of FIG. 3;

FIG. 5 is a perspective view of a cartridge of the battery back cover structure of a mobile telephone having the function of a hand-free receiver as shown in FIG. 1;

FIG. 6 is an exploded perspective view of the cartridge of the battery back cover structure of a mobile telephone having the function of a hand-free receiver as shown in FIG. 5,

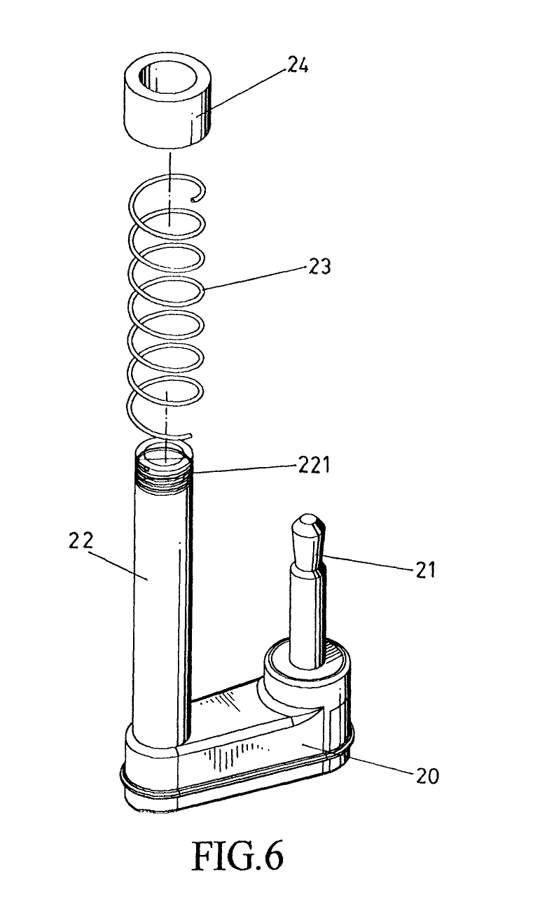

FIG. 7 is a rear perspective view of FIG. 3;

FIG. 8 is a circuit diagram of the battery back cover structure of a mobile telephone having the function of a hand-free receiver as shown in FIG. 1;

FIG. 9 is a circuit diagram of the battery back cover structure of a mobile telephone having the function of a hand-free receiver as shown in FIG. 1;

FIG. 10 is a circuit diagram of the battery back cover structure of a mobile telephone having the function of a hand-free receiver as shown in FIG. 1;

FIG. 11 is a circuit diagram of the battery back cover structure of a mobile telephone having the function of a hand-free receiver as shown in FIG. 1;

FIG. 12 is a perspective view of a battery back cover structure of a mobile telephone having the function of a hand-free receiver in accordance with a second embodiment of the present invention;

FIG. 13 is a front plan view of the battery back cover structure of a mobile telephone having the function of a hand-free receiver as shown in FIG. 12;

FIG. 14 is a side plan view of the battery back cover structure of a mobile telephone having the function of a hand-free receiver as shown in FIG. 12;

FIG. 15 is an operational view of the battery back cover structure of a mobile telephone having the function of a hand-free receiver as shown in FIG. 14;

FIG. 16 is a perspective view showing that the battery back cover structure as shown in FIG. 12 being assembled with a mobile telephone body; and

FIG. 17 is a side plan view of FIG. 16.

### DETAILED DESCRIPTION OF THE INVENTION

The hand-free receiver of a mobile telephone (or cellular phone) in accordance with the present invention is achieved by changing the battery back cover structure.

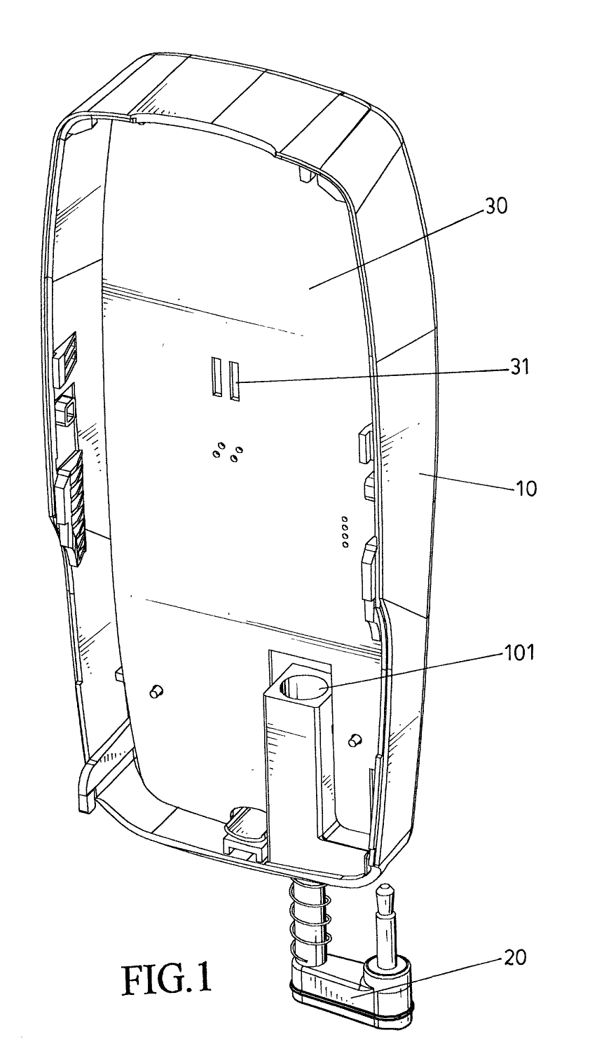

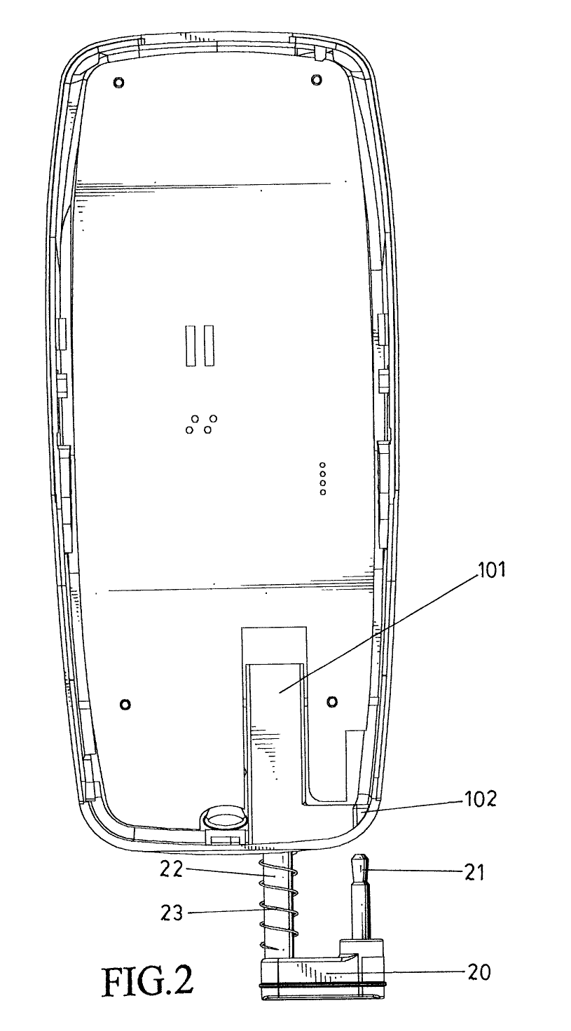

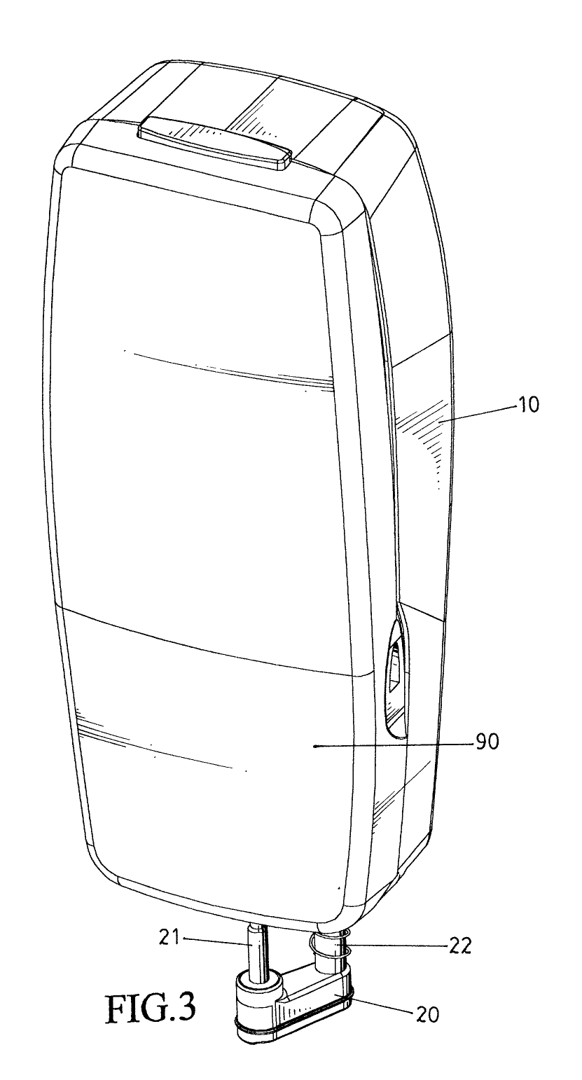

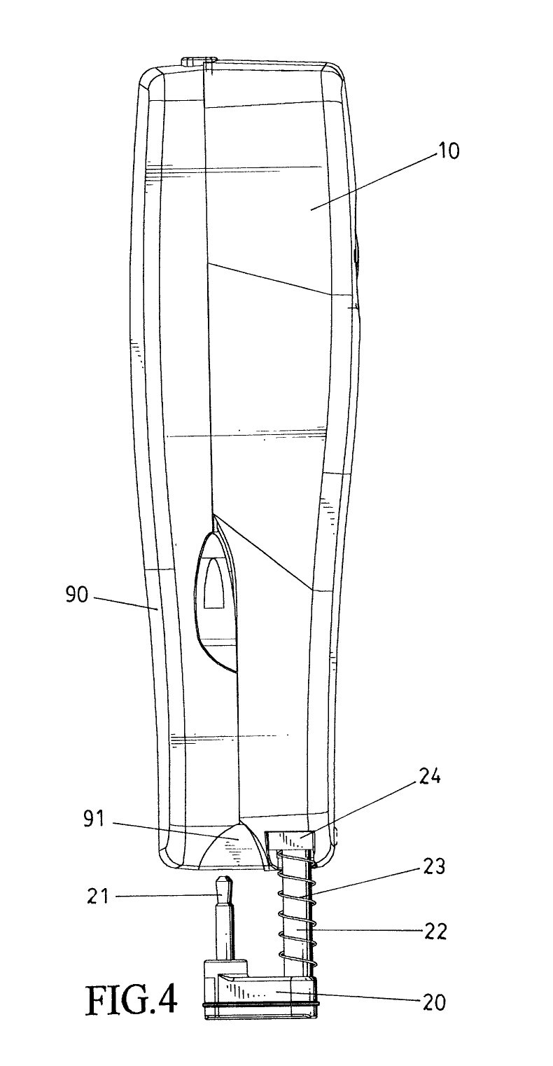

Referring to the drawings and initially to FIGS. 1 and 2, the battery back cover structure of a mobile telephone having the function of a hand-free receiver in accordance with a first embodiment of the present invention comprises a battery back cover 10 containing a control circuit board 30 of a hand-free receiver circuit, and a cartridge 20 that may be inserted into the bottom of the battery back cover 10. The cartridge 20 is provided with a signal connector 21 that may be inserted into the insertion hole 91 of the bottom of a mobile telephone body 90 as shown in FIGS. 3 and 4, so that the signal of the mobile telephone body 90 may be transferred to the cartridge 20 and the battery back cover 10, thereby forming the circuit connection.

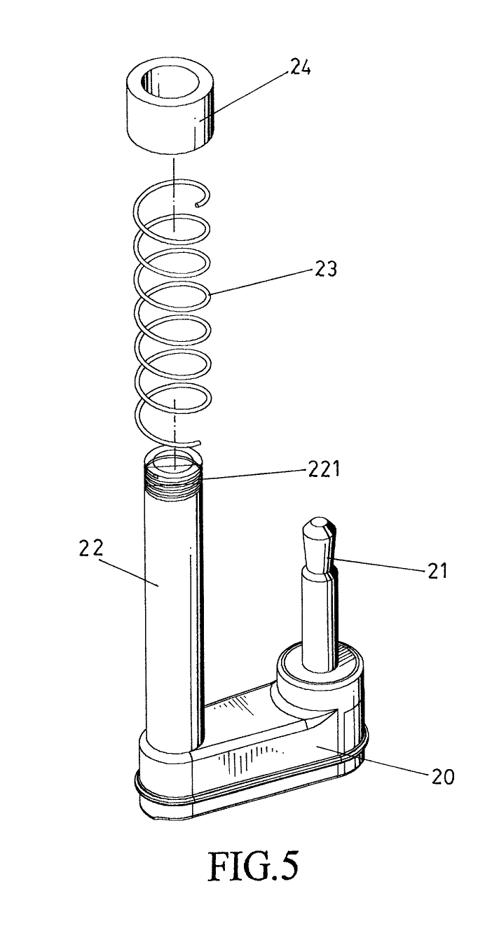

As shown in FIG. 5, the cartridge 20 is substantially a U-shaped base. The signal connector 21 at one end of the cartridge 20 is shorter, while the longer insertion column 22 at the other end of the cartridge 20 may be inserted into the column hole 101 of the battery back cover 10. After the insertion column 22 is inserted into the column hole 101, a spring 23 is fitted on the insertion column 22. The insertion column 22 may pass through the column hole 101, and a nut 24 is screwed on the outer thread 221 of the top end of the insertion column 22, thereby fixing the insertion column 22 in the column hole 101.

As shown in FIGS. 1 and 2, the signal connector 21 of the cartridge 20 is initially inserted into the insertion hole 102 of the battery back cover 10. When the mobile telephone body 90 is inserted into and combined with the battery back cover 10, the cartridge 20 may be pulled downward, so that the nut 24 is locked in the column hole 101 as shown in FIG. 4. The cartridge 20 is then rotated, and the signal connector 21 at one end of the cartridge 20 is inserted into the insertion hole 91 of the bottom of the mobile telephone body 90, so that the signal of the mobile telephone body 90 may be transferred to the cartridge 20 and the battery back cover 10.

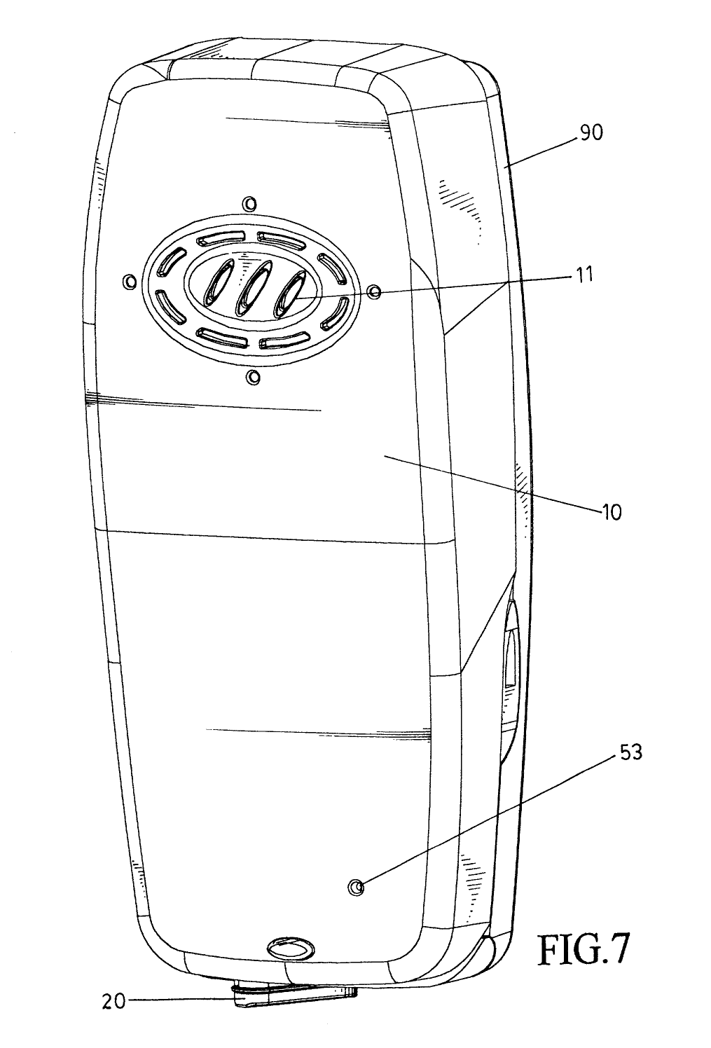

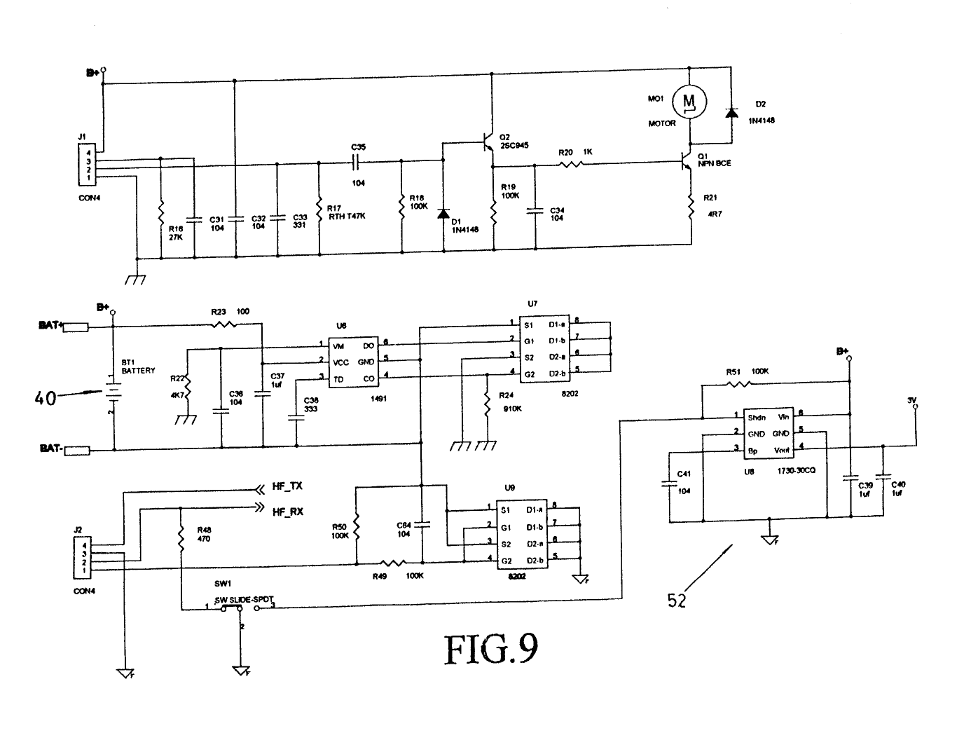

Referring to FIG. 7, the inner wall of the battery back cover 10 is serially provided with a horn 11, and the control circuit board 30 of the hand-free receiver (see FIG. 1). The electrode elastic plates 31 at the surface of the control circuit board 30 may contact the electrodes of the wall face of the battery 40 (see FIG. 9), thereby forming a power supply circuit, so as to supply the electric power required by the control circuit board 30. The electric power of the battery 40 is transmitted by the two mutually contacting electrode elastic plates 31 to the control circuit board 30 of the hand-free receiver. The mobile telephone body 90 is then mounted on the battery back cover 10, and the signal connector 21 of the cartridge 20 is inserted into the insertion hole 91 of the bottom of the mobile telephone body 90, so that the mobile telephone has the function of a hand-free receiver.

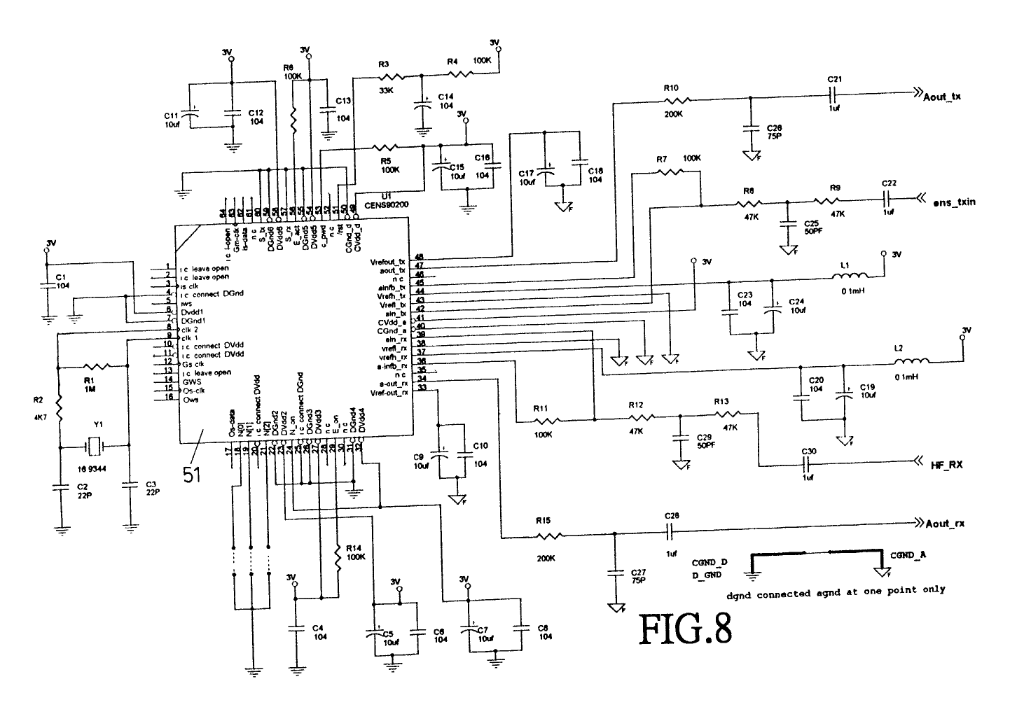

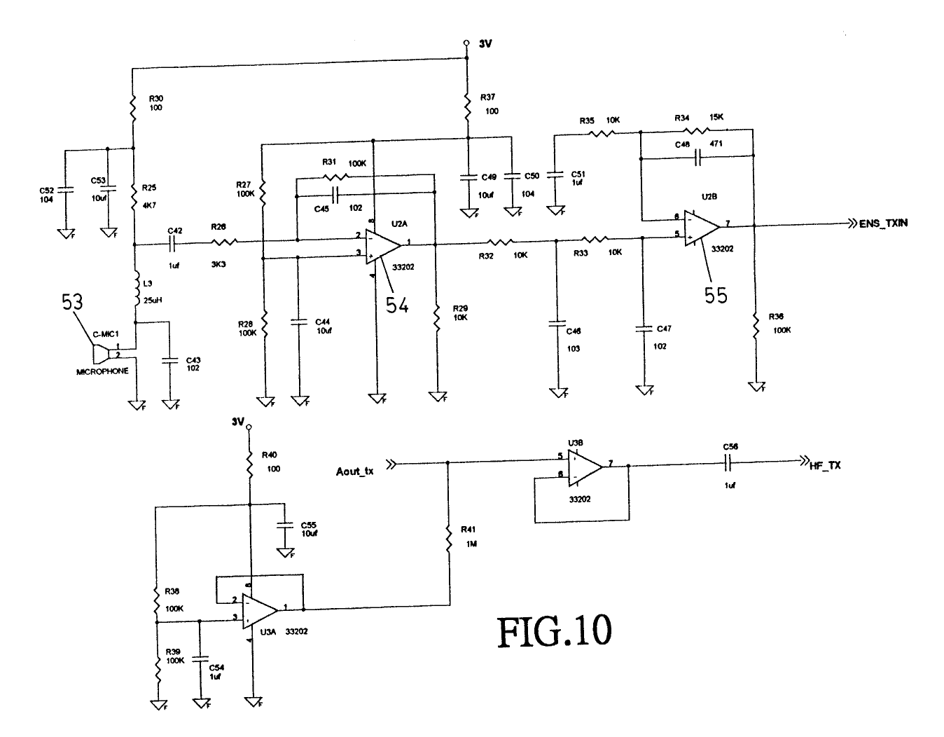

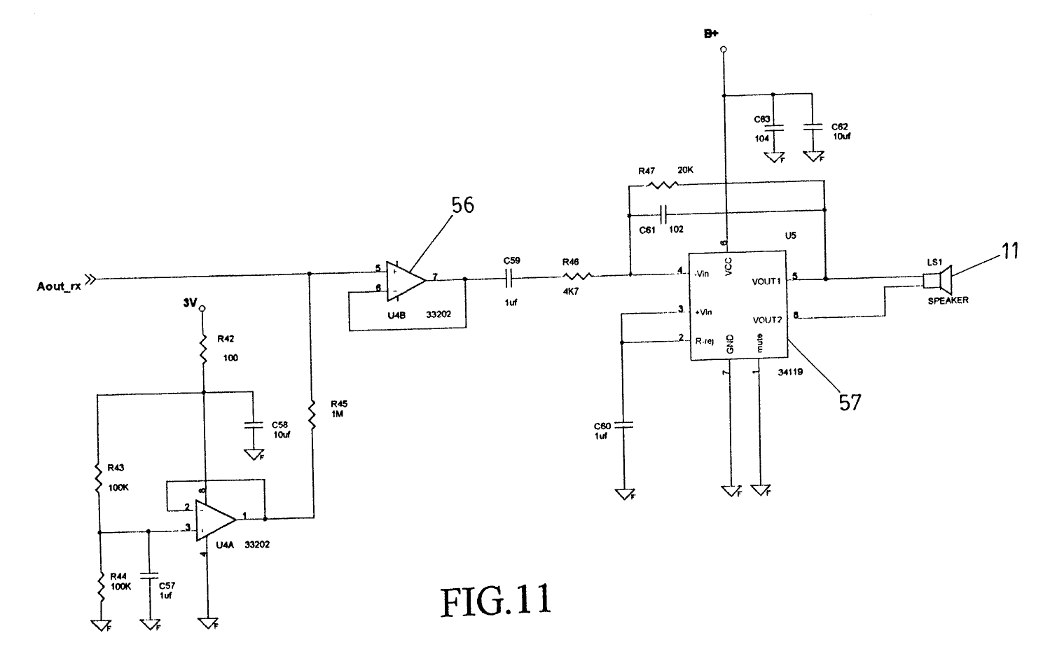

With regard to the circuit structure of the present invention, referring to FIG. 8, a microprocessor 51 serves as a control center. FIG. 9 shows a steady voltage circuit 52 that is connected to the battery 40. FIG. 10 shows operation amplifiers 54 and 55 that are connected to a microphone 53, and FIG. 11 shows an audio amplification circuit that is connected to the horn 11 and consists of an amplifier 56 and a power amplifier 57, thereby providing an audio signal input function.

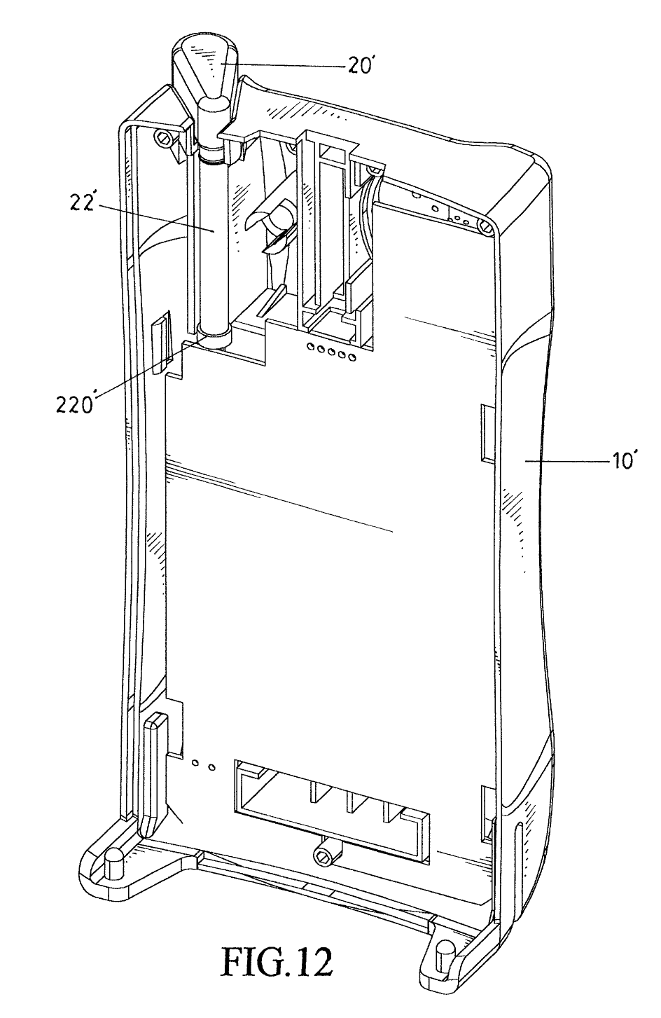

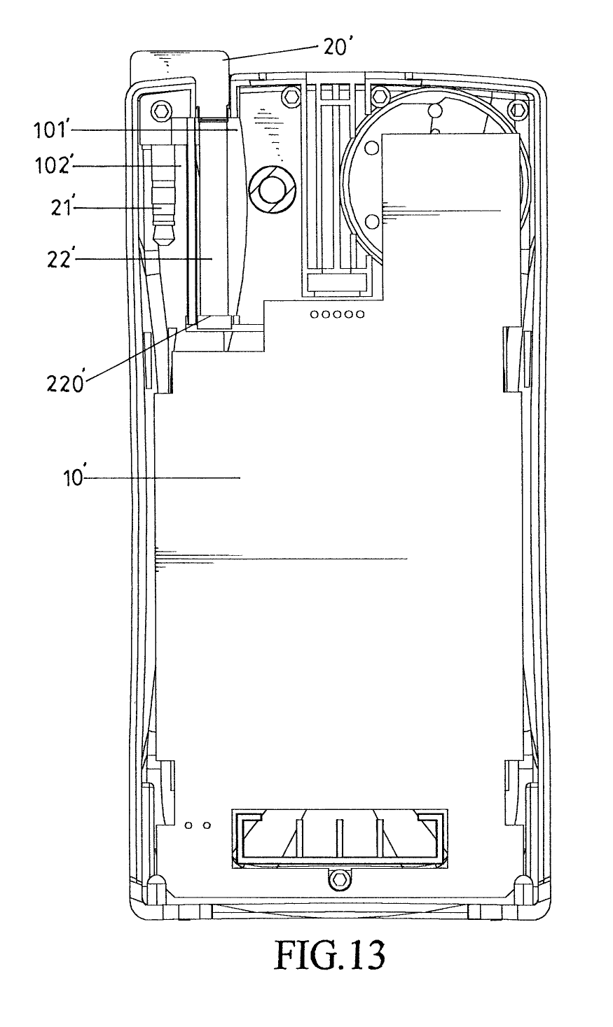

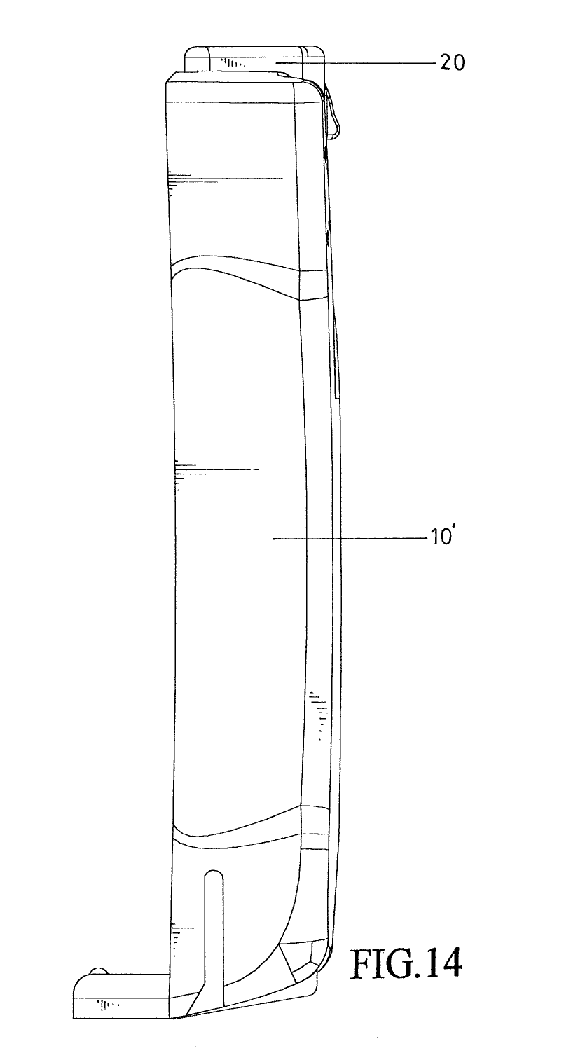

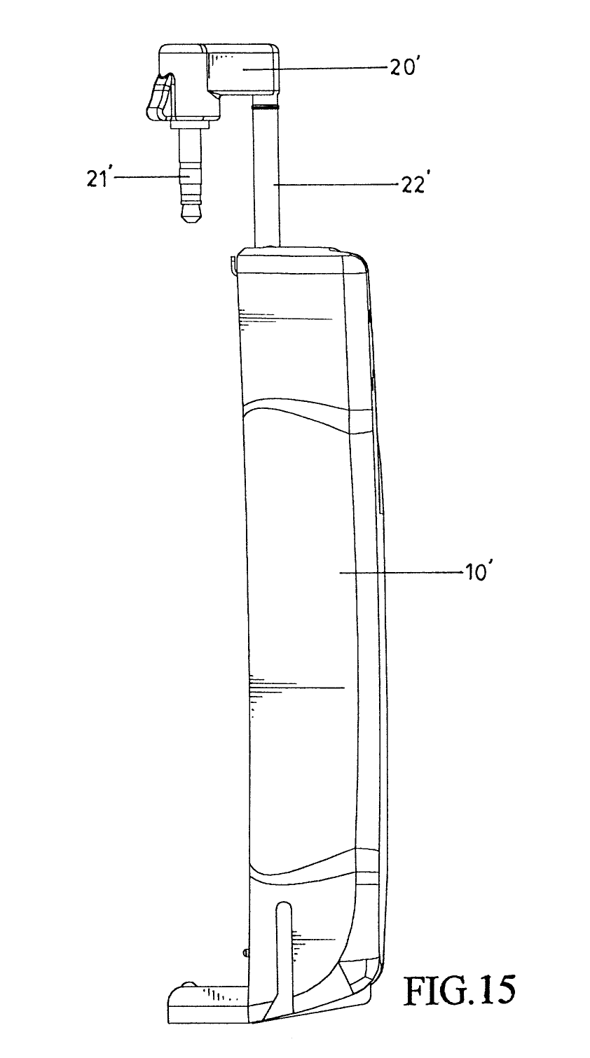

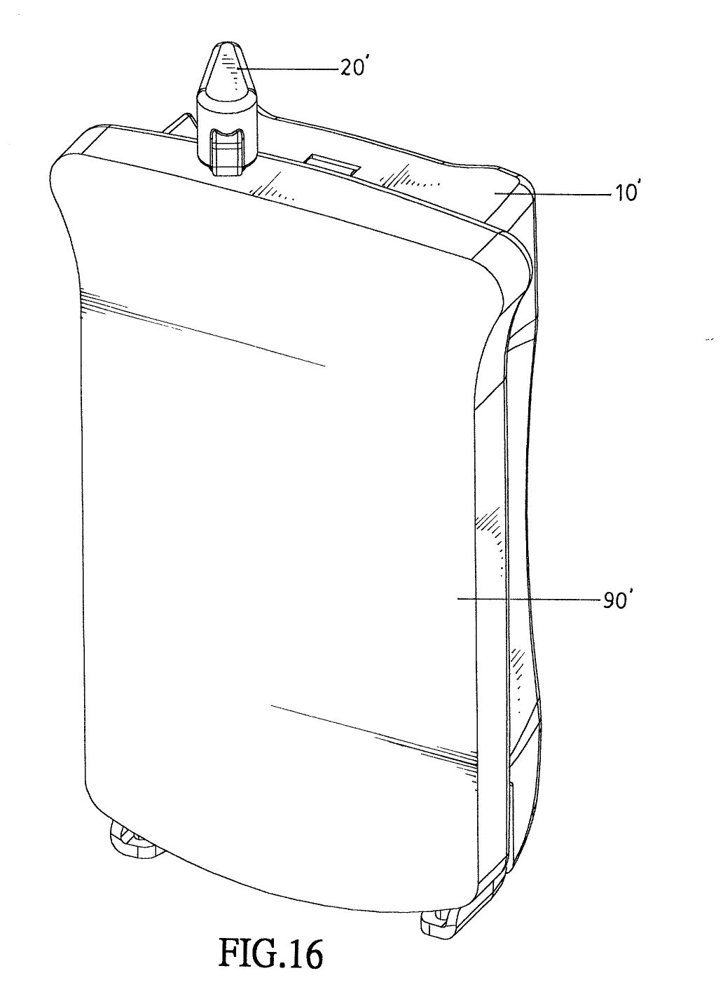

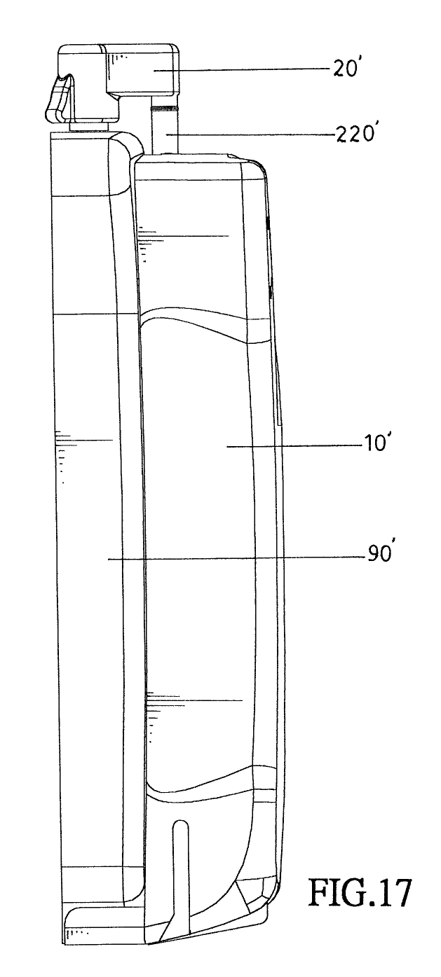

Referring to FIGS. 12-17, in accordance with a second embodiment of the present invention, the mobile telephone comprises a mobile telephone body 90′, a battery back cover 10′, and a cartridge 20′ snapped on the top end of the battery back cover 10′. The cartridge 20′ is substantially U-shaped. The signal connector 21′ at one end of the cartridge 20′ is shorter, while the longer insertion column 22′ at the other end of the cartridge 20′ may be inserted into the column hole 101′ of the top end of the battery back cover 10′. The cartridge 20′ may extend upward. The catch 220′ at the bottom end of the insertion column 22′ may be used to prevent the insertion column 22′ from detaching from the column hole 101′. The signal connector 21′ of the cartridge 20′ is initially inserted into the insertion hole 102′ of the battery back cover 10′ as shown in FIG. 13. When the mobile telephone body 90′ is inserted into and combined with the battery back cover 10′, the cartridge 20′ may be pulled upward and rotated as shown in FIG. 15. The signal connector 21′ at one end of the cartridge 20′ is inserted into the insertion hole of the top of the mobile telephone body 90′ as shown in FIGS. 16 and 17, so that the signal of the mobile telephone body 90′ may be transferred to the cartridge 20′ and the battery back cover 10′.

Accordingly, the present invention may mate with various types of mobile telephone body. The signal connector of the cartridge inserted into the insertion hole of the battery back cover may be pulled and rotated to be inserted into any appropriate insertion hole of the mobile telephone body, thereby providing the function of a hand-free receiver.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A battery back cover structure of a mobile telephone having a function of a hand-free receiver, comprising:
a battery back cover, having an inner wall provided with a horn and a microphone;
a control circuit board of a hand-free receiver, said control circuit board provided on an inner face of said battery back cover; and
a cartridge, inserted into a proper position of said battery back cover, and provided with a signal connector inserted into an insertion hole of a mobile telephone body, and connected to said control circuit board of said hand-free receiver, for transferring a signal from said mobile telephone body to said cartridge, and to said control circuit board of said hand-free receiver.

2. The battery back cover structure of a mobile telephone having a function of a hand-free receiver in accordance with claim 1, wherein said control circuit board of said hand-free receiver has a surface provided with electrode elastic plates which directly contact power supply connecting points of a battery of a mobile telephone.

3. The battery back cover structure of a mobile telephone having a function of a hand-free receiver in accordance with claim 1, wherein said cartridge is provided with an insertion column which may be inserted into a column hole of said battery back cover, an outer thread is formed on a top of said insertion column, a spring is fitted on said insertion column, and a nut is screwed on said outer thread of said insertion column and is secured in said column hole, thereby preventing said insertion column from detaching from said column hole.

4. The battery back cover structure of a mobile telephone having a function of a hand-free receiver in accordance with claim 1, wherein said cartridge is pulled downward and rotated, so that said signal connector of said cartridge can be inserted into said insertion hole of said mobile telephone body.

5. The battery back cover structure of a mobile telephone having a function of a hand-free receiver in accordance with claim 1, wherein said cartridge is provided with an insertion column which may be inserted into a column hole of said battery back cover, and a catch is mounted on one end of said insertion column to prevent said insertion column from detaching from said column hole.
